(19) United States
(12) Patent Application Publication
(10) Pub. No.: US 2025/0210227 A1
(43) Pub. Date: Jun. 26, 2025

(54) Flat Electric Wire

(71) Applicant: Yazaki Corporation, Tokyo (JP)

(72) Inventors: Mizuki Shirai, Shizuoka (JP); Tetsuya Nagumo, Shizouka (JP)

(21) Appl. No.: 19/075,228

(22) Filed: Mar. 10, 2025

Related U.S. Application Data
(63) Continuation of application No. PCT/JP2024/000192, filed on Jan. 9, 2024.

(30) Foreign Application Priority Data
Jan. 11, 2023 (JP) 2023-002582

(51) Int. Cl. H01B 7/08; H01B 1/02

(52) U.S. Cl. CPC H01B 7/0823; H01B 1/02

(57) ABSTRACT

A flat electric wire includes a plurality of conductor portions that are arranged in parallel and that are in contact with each other, and an insulator configured to collectively cover the plurality of conductor portions. The plurality of conductor portions include a stranded wire that is formed by stranding wires made of a first metal, and a solid wire made of a second metal that has a lower yield point than the first metal.

### CROSS-REFERENCE TO RELATED APPLICATIONS

This is a continuation of International Application No. PCT/JP2024/000192 filed on Jan. 9, 2024, and claims priority from Japanese Patent Application No. 2023-002582 filed on Jan. 11, 2023, the entire content of which is incorporated herein by reference.

### TECHNICAL FIELD

The present disclosure relates to a flat electric wire.

### BACKGROUND ART

In the related art, a flat electric wire has been proposed in which a conductor is covered with an insulator to give the entire electric wire a flat shape. Such flat electric wires include a flat electric wire in which a conductor is formed of a busbar as disclosed in, for example, see JP2020-053377A, and a flat electric wire in which a plurality of stranded wires formed by twisting a large number of wires are arranged in parallel to form a conductor as disclosed in, for example, see JP2021-157968A.

Regarding the flat electric wire described in JP2020-053377A, since the conductor is formed of the busbar, the flat electric wire has excellent shape retention performance but poor flexibility. On the other hand, regarding the flat electric wire described in JP2021-157968A, since the conductor is formed of a plurality of stranded wires, the flat electric wire has excellent flexibility but poor shape retention performance. Therefore, in the related art, the flat electric wire described in JP2020-053377A is used in a place where the shape retention is required, and the flat electric wire described in JP2021-157968A is used in a place where the flexibility is required. Therefore, a flat electric wire that achieves both the shape retention and the flexibility is desired.

The present disclosure has been made to solve such problems in the related art, and an object of the present disclosure is to provide a flat electric wire capable of achieving both the shape retention and the flexibility.

### SUMMARY OF INVENTION

According to the present disclosure, a flat electric wire includes a plurality of conductor portions that are arranged in parallel and that are in contact with each other, and an insulator configured to collectively cover the plurality of conductor portions. The plurality of conductor portions include a stranded wire that is formed by stranding wires made of a first metal, and a solid wire made of a second metal that has a lower yield point than the first metal.

According to the present disclosure, it is possible to provide a flat electric wire capable of achieving both the shape retention and the flexibility.

### BRIEF DESCRIPTION OF DRAWINGS

FIG. 1 is a cross-sectional view showing a flat electric wire according to an embodiment of the present disclosure;

FIG. 2 is a stress-strain diagram showing a correlation between stress and strain for pure copper and pure aluminum;

FIG. 3 is a chart showing the conductor size of a solid wire shown in FIG. 1;

FIG. 4 is a chart showing examples and comparative examples; and

FIGS. 5A to 5C are process diagrams showing the state of a shape retention test, in which FIG. 5A is a first step, FIG. 5B is a second step, and FIG. 5C is a third step.

### DESCRIPTION OF EMBODIMENTS

Hereinafter, the present disclosure will be described with reference to a preferred embodiment. The present disclosure is not limited to the embodiment to be described below, and the embodiment can be appropriately changed without departing from the gist of the present disclosure. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

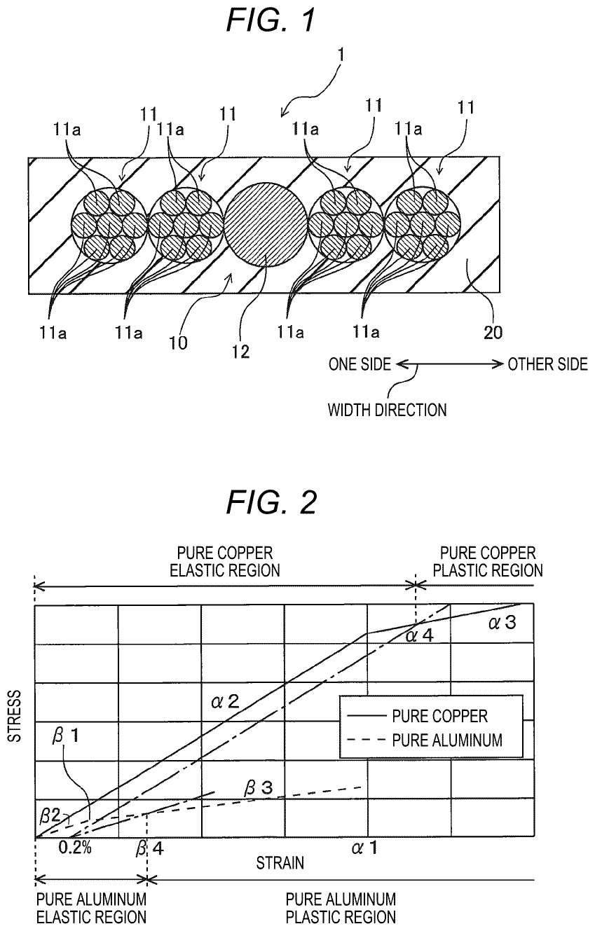

FIG. 1 is a cross-sectional view showing a flat electric wire according to an embodiment of the present disclosure. As shown in FIG. 1, a flat electric wire 1 according to the present embodiment includes a plurality of conductor portions 10 and an insulator 20.

The plurality of conductor portions 10 are elongated conductive linear bodies for transmitting electric power, a signal, and the like, and include a stranded wire 11 and a solid wire 12 that are arranged in parallel and that are in contact with each other. In the present embodiment, the plurality of conductor portions 10 are implemented by four stranded wires 11 and one solid wire 12. The stranded wire 11 is formed by stranding a large number of wires 11a made of a first metal (for example, pure copper). The solid wire 12 is made of a second metal (for example, pure aluminum) that is more likely to be plastically deformed than the first metal.

FIG. 2 is a stress-strain diagram showing a correlation between stress and strain for pure copper and pure aluminum. As shown in FIG. 2, pure copper has a characteristic that, in the stress-strain diagram, up to a strain α1, pure copper has a certain gradient α2, and when the strain α1 is exceeded, pure copper has a gradient α3. Here, when the yield point is obtained based on the 0.2% proof stress (that is, when a straight line with the gradient α2 is drawn from a strain 0.2% and the intersection with the pure copper property is obtained), the yield point is at a strain α4. Therefore, it can be said that pure copper is elastically deformable at the strain α4 or less, and is plastically deformed when the strain α4 is exceeded.

Pure aluminum shown in FIG. 2 has a characteristic that, in the stress-strain diagram, up to a strain β1, pure aluminum has a certain gradient β2, and when the strain β1 is exceeded, pure aluminum has a gradient β3. Here, when the yield point is obtained based on the 0.2% proof stress (that is, when a straight line with the gradient β2 is drawn from a strain 0.2% and the intersection with the pure aluminum property is obtained), the yield point is at a strain β4. Therefore, it can be said that the pure aluminum is elastically deformable at the strain β4 or less, and is plastically deformed when the strain β4 is exceeded. In particular, the strain β4 is smaller than the strain α4, and pure aluminum is more likely to be plastically deformed than pure copper. In this way, the second metal used for the solid wire 12 is more likely to be plastically deformed than the first metal forming the stranded wire 11.

In the present embodiment, the first metal is, for example, pure copper, and the second metal is pure aluminum, but is not particularly limited to these metals.

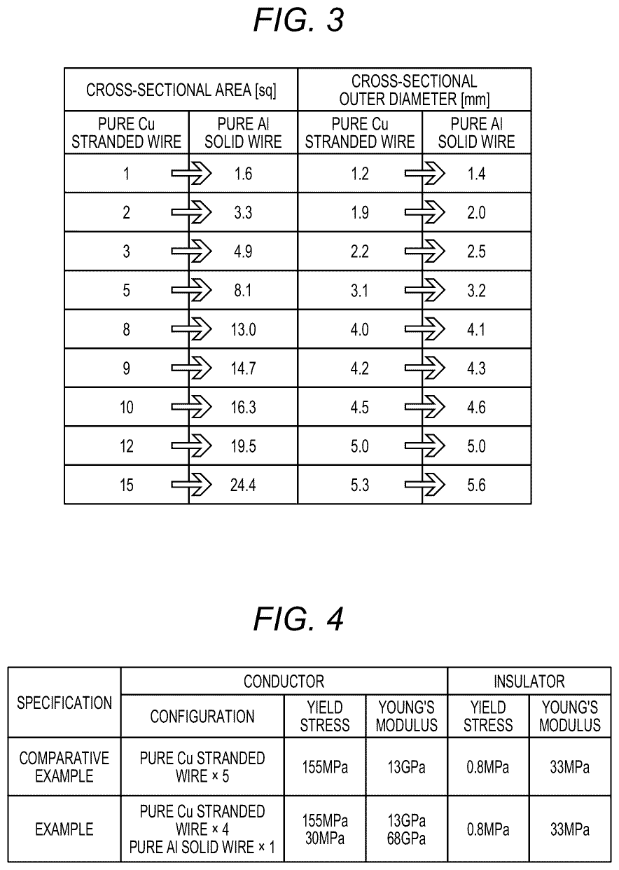

Reference is made again to FIG. 1. The solid wire 12 shown in FIG. 1 preferably has a conductor size that is equal to or less than that of the electrical resistor of the stranded wire 11. FIG. 3 is a chart showing the conductor size of the solid wire 12 shown in FIG. 1. When the first metal is pure copper and the second metal is pure aluminum, the cross-sectional area and the outer diameter of the conductor of the solid wire 12 have the relationship shown in FIG. 3 with the stranded wire 11.

Specifically, when the cross-sectional area of the stranded wire 11 is 1 sq, the cross-sectional area of the solid wire 12 is 1.6 sq or more. Similarly, when the cross-sectional area of the stranded wire 11 is 2 sq, 3 sq, 5 sq, 8 sq, 9 sq, 10 sq, 12 sq, and 15 sq, the cross-sectional area of the solid wire 12 is 3.3 sq, 4.9 sq, 8.1 sq, 13.0 sq, 14.7 sq, 16.3 sq, 19.5 sq, and 24.4 sq or more in order. When the outer diameter of the stranded wire 11 is 1.2 mm, the outer diameter of the solid wire 12 is 1.4 mm or more. Similarly, when the outer diameter of the stranded wire 11 is 1.9 mm, 2.2 mm, 3.1 mm, 4.0 mm, 4.2 mm, 4.5 mm, 5.0 mm, and 5.3 mm, the outer diameter of the solid wire 12 is 2.0 mm, 2.5 mm, 3.2 mm, 4.1 mm, 4.3 mm, 4.6 mm, 5.0 mm, and 5.6 mm or more in order.

In this way, by setting the conductor size of the solid wire 12 to be equal to or less than that of the electrical resistor of the stranded wire 11, it is possible to prevent an increase in electrical resistance due to the fact that a part of the plurality of conductor portions 10 are made of different metals.

Reference is made again to FIG. 1. In the plurality of conductor portions 10 shown in FIG. 1, the stranded wire 11 and the solid wire 12 are arranged symmetrically in the width direction. In the present embodiment, since the conductor portion 10 is implemented by the four stranded wires 11 and the single solid wire 12, the solid wire 12 is provided at the center of the five conductor portions 10. The configuration is not particularly limited to the configuration in which the solid wire 12 is provided at the center as long as the plurality of conductor portions 10 are arranged symmetrically in the width direction. For example, the conductor portion 10 may be implemented by four stranded wires 11 and two solid wires 12 provided on both ends of the four stranded wires 11.

The insulator 20 collectively covers the plurality of conductor portions 10. The insulator 20 is made of a resin (for example, soft PVC) having a Young's modulus of 35 MPa or less. This is because the shape retention can be easily ensured using a resin having a Young's modulus of 35 MPa or less as the insulator 20. More specifically, for example, when the first metal is pure copper and the second metal is pure aluminum, and the plurality of conductor portions 10 are implemented by four stranded wires 11 and one solid wire 12 provided at the center, the shape can be retained when bent at 90° with R30.

Examples and Comparative Examples will be described below. FIG. 4 is a chart showing the examples and the comparative examples.

In the comparative example shown in FIG. 4, the plurality of conductor portions were implemented by five stranded wires made of pure copper. The yield stress of the stranded wire was 155 MPa, and the Young's modulus was 13 GPa. The yield stress of the insulator was 0.8 MPa, and the Young's modulus was 33 MPa.

In the example, the plurality of conductor portions were implemented by four stranded wires that are made of pure copper and one solid wire that is made of pure aluminum and that is provided at the center. The characteristics of the stranded wire are the same as those in the comparative example. The yield stress of the solid wire was 30 MPa, and the Young's modulus was 68 GPa. The insulator is the same as that in the comparative example.

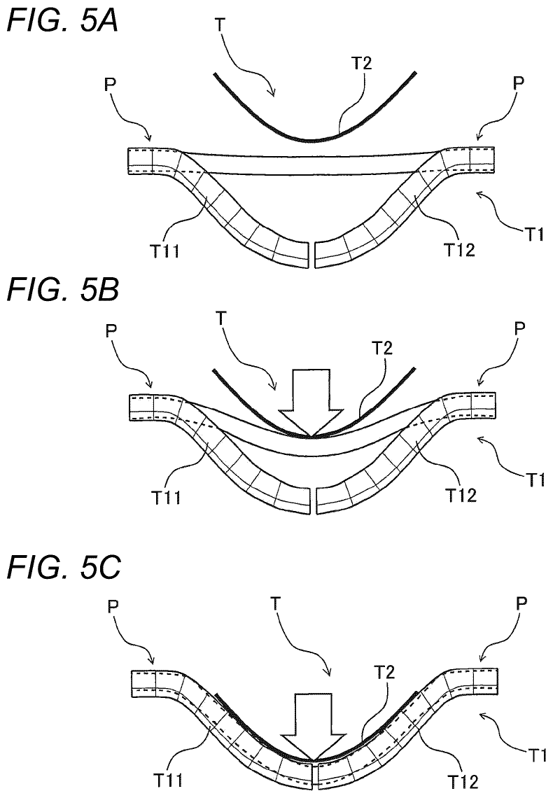

FIGS. 5A to 5C are process diagrams showing the state of a shape retention test, in which FIG. 5A is a first step, FIG. 5B is a second step, and FIG. 5C is a third step. A test device T shown in FIGS. 5A to 5C includes a first jig T1 and a second jig T2. The first jig T1 has a cross-sectional shape that is a concave shape in which the upper side is the open side, and has a curved shape for performing bending at 90° with R30 when viewed from the side. When viewed from the side, both ends of the first jig T1 serve as placement portions P for the flat electric wire. The first jig T1 includes a first member T11 and a second member T12, and has a structure that is divided at the curved central portion. The second jig T2 has a rigidity for bending the flat electric wire shown in the example and the comparative example, and has a curved shape for performing bending at 90° with R30 when viewed from the side. The second jig T2 is provided above the first jig T1 and moves up and down.

First, in the shape retention test, as shown in FIG. 5A, the first step is performed. In the first step, the flat electric wires according to the example and the comparative example are linearly placed on the placement portion P of the first jig T1. Next, as shown in FIG. 5B, in the second step, the second jig T2 is moved downward. Accordingly, the flat electric wire that is placed on the placement portion P is bent. Thereafter, as shown in FIG. 5C, the second jig T2 is further moved downward, and the flat electric wire is bent at 90° with R30. Thereafter, the second jig T2 is moved upward, and the flat electric wire is taken out.

As a result of such a test, the flat electric wire according to the example maintained the state of being bent at 90° with R30, but the flat electric wire according to the comparative example did not maintain the state of being bent at 90°.

Therefore, it was confirmed that the flat electric wire 1 including the plurality of conductor portions 10 including the stranded wire 11 and the solid wire 12 is superior to the flat electric wire including only the stranded wire 11 in shape retention performance. It was also found that the shape can be retained if four stranded wires 11 made of pure copper and a solid wire 12 made of pure aluminum and provided at the center are provided, and if the Young's modulus is 33 MPa.

As described above, according to the flat electric wire 1 in the present embodiment, since the plurality of conductor portions 10 include the stranded wire 11 that is formed by stranding the wires made of the first metal, it is possible to easily ensure the flexibility. Further, the plurality of conductor portions 10 include the solid wire 12 made of the second metal that is more likely to be plastically deformed than the first metal. Therefore, for example, when the flat electric wire 1 is bent at a bending portion, the solid wire 12 is likely to be plastically deformed and easily retains the bent shape. Therefore, it is possible to provide the flat electric wire 1 capable of achieving both the shape retention and the flexibility.

Since the solid wire 12 has a conductor size that is equal to or less than that of the electrical resistor of the stranded wire 11, it is possible to prevent an increase in electrical resistance due to the presence of the solid wire 12 in the stranded wire 11.

The stranded wire 11 and the solid wire 12 are arranged symmetrically in the width direction. Therefore, for example, when the stranded wire 11 is provided on one side in the width direction and the solid wire 12 is provided on the other side in the width direction, the stranded wire 11 provided on only one side in the width direction exerts a force tending to return to the original shape when bent, which causes distortion. However, by arranging the stranded wire 11 and the solid wire 12 symmetrically, the occurrence of distortion can be reduced.

When the second metal is pure aluminum, since the Young's modulus of the insulator 20 is 35 MPa or less, it is possible to prevent the stress of the insulator 20 from exceeding the shape retention performance of pure aluminum and to perform shape retention.

Although the present disclosure is described above based on the embodiment, the present disclosure is not limited to the embodiment described above, a modification may be made without departing from the gist of the present disclosure, and the known or well-known techniques may be combined.

For example, in the present embodiment, the number of the plurality of conductor portions 10 is five, but is not particularly limited thereto, and may be two or more and four or less, or may be six or more. The number of stranded wires 11 is not limited to four, and may be one or more and three or less, or may be five or more. Similarly, the number of solid wires 12 may be two or more. In the example shown in FIG. 1, the number of wires 11a is seven, but is not limited thereto, and may be two or more and six or less, or may be eight or more.

In the embodiment described above, the plurality of conductor portions 10 are arranged in a row of five to form a single layer structure, but the present disclosure is not particularly limited thereto, and the conductor portions may be stacked in two or more layers.

What is claimed is:

1. A flat electric wire comprising:
a plurality of conductor portions that are arranged in parallel and that are in contact with each other; and
an insulator configured to collectively cover the plurality of conductor portions,
wherein the plurality of conductor portions include a stranded wire that is formed by stranding wires made of a first metal, and a solid wire made of a second metal that has a lower yield point than the first metal.

2. The flat electric wire according to claim 1,
wherein the conductor size of the solid wire is set to ensure that the resistance of the solid wire is equal to or less than the resistance of the stranded wire.

3. The flat electric wire according to claim 1,
wherein the stranded wire and the solid wire are arranged symmetrically in a width direction.

4. The flat electric wire according to claim 1,
wherein the second metal is pure aluminum, and
wherein the insulator has a Young's modulus of 35 MPa or less.
